(19) United States
(12) Patent Application Publication
(10) Pub. No.: US 2022/0271628 A1
(43) Pub. Date: Aug. 25, 2022

(54) ROTATING ELECTRIC MACHINE AND DRIVE APPARATUS

(71) Applicant: NIDEC CORPORATION, Kyoto (JP)

(72) Inventor: Takahiro MIKI, Kyoto (JP)

(21) Appl. No.: 17/672,596

(22) Filed: Feb. 15, 2022

(30) Foreign Application Priority Data
Feb. 24, 2021 (JP) 2021-027503

(51) Int. Cl. H02K 11/25; H02K 3/50; H02K 5/20; H02K 7/116; H02K 9/193

(52) U.S. Cl. CPC H02K 11/25; H02K 3/50; H02K 5/203; H02K 7/116; H02K 9/193; H02K 2203/06

(57) ABSTRACT

A rotating electric machine includes: a rotor rotatable about a central axis; a stator; a temperature detection unit measuring the temperature of the stator; and a refrigerant supply unit supplying a refrigerant to the stator. The stator includes a stator core and a coil assembly held by the stator core. The coil assembly includes a coil end protruding from the stator core in an axial direction, coil lead wires, and at least one neutral point member electrically connecting ends of the coil lead wires and arranged at the coil end. The temperature detection unit is arranged in a temperature detection region being a partial region in a circumferential direction of the coil end. The refrigerant supply unit has a refrigerant supply hole that opens toward the temperature detection region. At least a part of the at least one neutral point member is arranged in the temperature detection region.

### CROSS-REFERENCE TO RELATED APPLICATIONS

The present invention claims priority under 35 U.S.C. § 119 to Japanese Patent Application No. 2021-027503 filed on Feb. 24, 2021, the entire content of which is incorporated herein by reference.

### FIELD OF THE INVENTION

The present invention relates to a rotating electric machine and a drive apparatus.

### BACKGROUND

A rotating electric machine includes a rotor rotatable about a central axis, and a stator located radially outside the rotor. Conventionally, a rotating electric machine used as a power source of a hybrid car, an electric vehicle, or the like is known. The conventional rotating electric machine includes a temperature detecting element that is arranged in contact with a coil end portion and detects a coil temperature. The temperature detecting element is provided at a position on the coil end portion so as not to come into direct contact with a refrigerant.

There is a case where a current value varies in each phase of a U phase, a V phase, and a W phase of a coil of the stator. In such a case, it has been difficult to accurately measure the temperature of a coil end.

### SUMMARY

An exemplary rotating electric machine of the present invention includes: a rotor rotatable about a central axis; a stator located radially outside the rotor; a temperature detection unit that measures the temperature of the stator; and a refrigerant supply unit that supplies a refrigerant to the stator. The stator includes a stator core and a coil assembly held by the stator core. The coil assembly includes a coil end that protrudes from the stator core in an axial direction, a plurality of coil lead wires, and at least one neutral point member that electrically connects ends of the plurality of coil lead wires to each other and is arranged at the coil end. The temperature detection unit is arranged in a temperature detection region that is a partial region in a circumferential direction of the coil end. The refrigerant supply unit has a refrigerant supply hole that opens toward the temperature detection region of the coil end. At least a part of the at least one neutral point member is arranged in the temperature detection region.

An exemplary drive apparatus of the present invention includes: the above-described rotating electric machine; a reduction gear connected to the rotating electric machine; a differential gear connected to the rotating electric machine via the reduction gear; and a housing that houses the rotating electric machine, the reduction gear, and the differential gear. The refrigerant supply unit supplies the stator with the refrigerant circulating inside the housing.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is an overall configuration view schematically illustrating a drive apparatus of the present embodiment;

FIG. 2 is a perspective view illustrating the drive apparatus of the present embodiment;

FIG. 3 is a partial cross-sectional view illustrating the drive apparatus of the present embodiment and is a cross-sectional view taken along line III-III in FIG. 2;

FIG. 4 is a perspective view illustrating a part of the drive apparatus of the present embodiment;

FIG. 5 is a perspective view illustrating a part of a stator of the present embodiment;

FIG. 6 is a perspective view illustrating a part of a rotating electric machine of the present embodiment;

FIG. 7 is a front view illustrating a part of the rotating electric machine of the present embodiment;

FIG. 8 is an overall configuration view schematically illustrating the rotating electric machine of the present embodiment;

FIG. 9 is a front view illustrating a part of the rotating electric machine of the present embodiment;

FIG. 10 is a front view illustrating a part of a rotating electric machine of a first modification of the present embodiment;

FIG. 11 is a front view illustrating a part of a rotating electric machine of a second modification of the present embodiment; and

FIG. 12 is a front view illustrating a part of a rotating electric machine of a third modification of the present embodiment.

### DETAILED DESCRIPTION

In the following description, a vertical direction is defined based on a positional relationship when a drive apparatus 1 of an embodiment illustrated in each drawing is mounted on a vehicle (not illustrated) located on a horizontal road surface. In addition, in the drawings, an XYZ coordinate system is illustrated appropriately as a three-dimensional orthogonal coordinate system. In the XYZ coordinate system, a Z-axis direction is the vertical direction. A +Z side is an upper side in the vertical direction, and a −Z side is a lower side in the vertical direction. In the following description, the upper side and the lower side in the vertical direction will be referred to simply as the “upper side” and the “lower side”, respectively. An X-axis direction is a direction orthogonal to the Z-axis direction and is a front-rear direction of the vehicle on which the drive apparatus 1 is mounted. In the following embodiment, a +X side is a front side of the vehicle, and a −X side is a rear side of the vehicle. A Y-axis direction is a direction orthogonal to both the X-axis direction and the Z-axis direction, and is a left-right direction of the vehicle, that is, a vehicle width direction. In the following embodiment, a +Y side is a left side of the vehicle, and a −Y side is a right side of the vehicle. Each of the front-rear direction and the left-right direction is a horizontal direction orthogonal to the vertical direction.

Note that the positional relationship in the front-rear direction is not limited to the positional relationship in the following embodiment, and the +X side may be the rear side of the vehicle and the −X side may be the front side of the vehicle. In this case, the +Y side is the right side of the vehicle, and the −Y side is the left side of the vehicle.

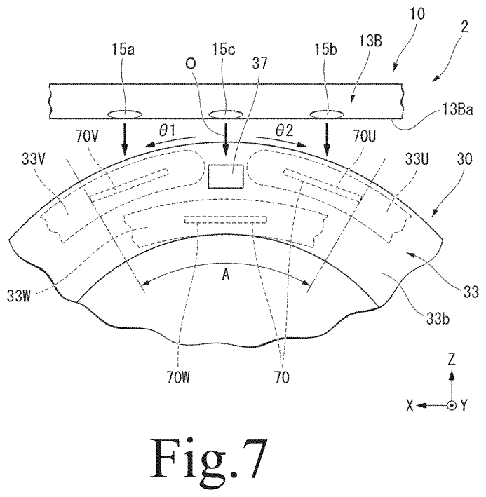

A rotating electric machine 2 is a power source of the vehicle. The rotating electric machine 2 is a motor that drives an axle 55. Therefore, the rotating electric machine 2 may be referred to as the motor 2, and a central axis J1 of the rotating electric machine 2 may be referred to as a motor axis J1. The central axis J1 illustrated appropriately in the drawings extends in the Y-axis direction, that is, the left-right direction of the vehicle. In the following description, a direction parallel to the central axis J1 is simply referred to as an “axial direction”, a radial direction about the central axis J1 is simply referred to as the “radial direction”, and a circumferential direction about the central axis J1, that is, a direction around the central axis J1 is simply referred to as the “circumferential direction” unless otherwise particularly stated. In the circumferential direction, a predetermined direction is referred to as one circumferential side θ1, and a direction opposite to the one circumferential side θ1 is referred to as the other circumferential side θ2. As illustrated in FIG. 7, the one circumferential side θ1 and the other circumferential side θ2 correspond to a counterclockwise direction around the central axis J1 and a clockwise direction, respectively, when the rotating electric machine 2 is viewed from the left side (+Y side) in the present embodiment. Note that, in the present specification, a “parallel direction” includes a substantially parallel direction, and an “orthogonal direction” includes a substantially orthogonal direction.

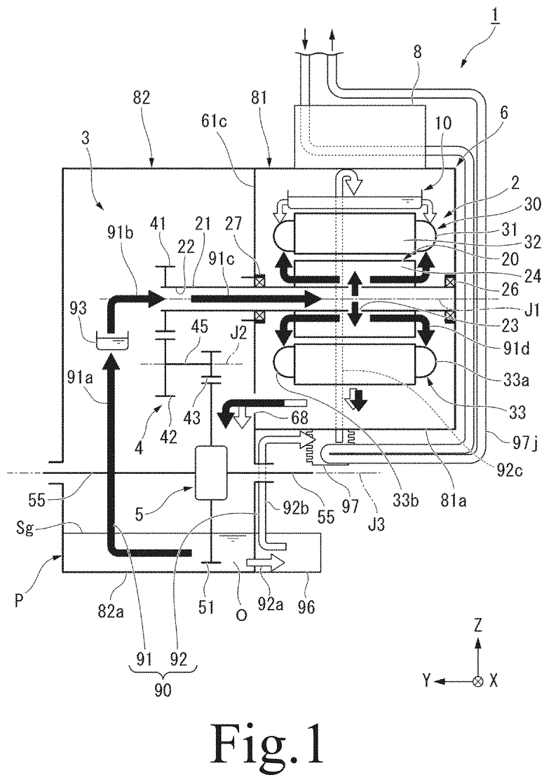

The drive apparatus 1 according to the present embodiment illustrated in FIG. 1 is mounted on a vehicle having a motor as a power source, such as a hybrid electric vehicle (HEV), a plug-in hybrid vehicle (PHV), and an electric vehicle (EV), and is used as the power source thereof. As illustrated in FIG. 1, the drive apparatus 1 includes a housing 6, an inverter unit 8, the rotating electric machine 2, and a transmission 3. The transmission 3 includes a reduction gear 4 and a differential gear 5. That is, the drive apparatus 1 includes the reduction gear 4 and the differential gear 5.

The housing 6 houses the rotating electric machine 2, the reduction gear 4, and the differential gear 5. The housing 6 includes a motor housing portion 81, a gear housing portion 82, and a partition wall 61c. The motor housing portion 81 is a portion that houses a rotor 20 and a stator 30, which will be described later, therein. The gear housing portion 82 is a portion that houses the transmission 3 therein. The gear housing portion 82 is located on the left side (+Y side) of the motor housing portion 81. A bottom 81a of the motor housing portion 81 is located above a bottom 82a of the gear housing portion 82. The partition wall 61c partitions the inside of the motor housing portion 81 and the inside of the gear housing portion 82 from each other in the axial direction. The partition wall 61c is provided with a partition wall opening 68. The partition wall opening 68 connects the inside of the motor housing portion 81 and the inside of the gear housing portion 82.

Oil O is contained in the inside of the motor housing portion 81 and the inside of the gear housing portion 82. An oil pool P in which the oil O is accumulated is provided in an inner lower region of the gear housing portion 82. The oil O in the oil pool P is fed to the inside of the motor housing portion 81 through an oil passage 90 to be described later. The oil O fed to the inside of the motor housing portion 81 is accumulated in an inner lower region of the motor housing portion 81. At least some of the oil O having accumulated in the inside of the motor housing portion 81 moves to the gear housing portion 82 through the partition wall opening 68 and is returned to the oil pool P.

Note that “the oil is contained inside a certain portion” in the present specification means that it is sufficient for the oil to be located inside the certain portion at least partly during driving of the rotating electric machine, and thus, the oil does not need to be located inside the certain portion when the rotating electric machine is stopped. For example, “the oil O is contained inside the motor housing portion 81” in the present embodiment means that it is sufficient for the oil O to be located inside the motor housing portion 81 at least partly during driving of the rotating electric machine 2 or the entire oil O in the motor housing portion 81 may move to the gear housing portion 82 through the partition wall opening 68 when the rotating electric machine 2 is stopped. Note that, some of the oil O fed to the inside of the motor housing portion 81 through the oil passage 90 to be described later may remain in the inside of the motor housing portion 81 in a state in which the rotating electric machine 2 is stopped.

The oil O circulates inside the oil passage 90 to be described later. The oil O is used to lubricate the reduction gear 4 and the differential gear 5. In addition, the oil O is also used to cool the rotating electric machine 2. That is, the refrigerant of the present embodiment is the oil O. As the oil O, it is preferable to use oil equivalent to an automatic transmission fluid (ATF) with a relatively low viscosity in order to achieve functions of lubricating oil and cooling oil.

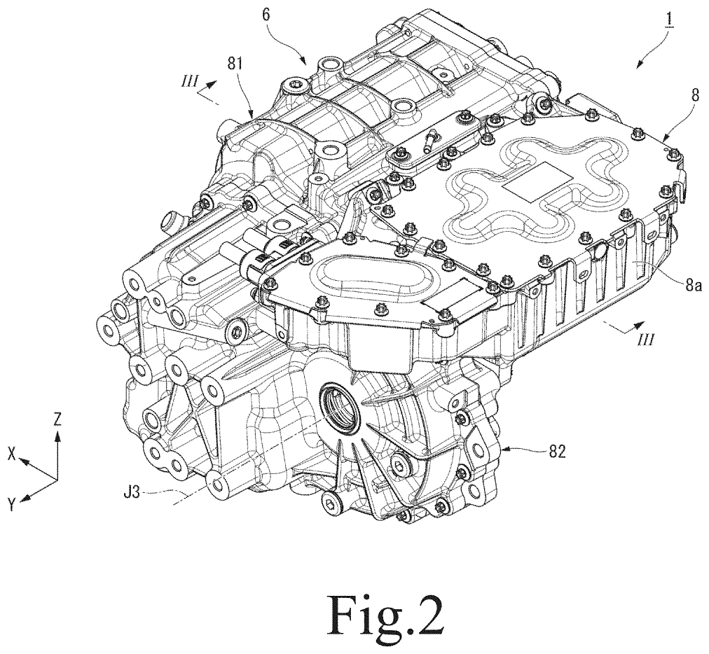

The bottom 82a of the gear housing portion 82 is located below the bottom 81a of the motor housing portion 81. Thus, the oil O fed from the gear housing portion 82 to the motor housing portion 81 easily flows into the gear housing portion 82 through the partition wall opening 68. As illustrated in FIG. 2, the gear housing portion 82 extends in the front-rear direction. An end of the gear housing portion 82 on the front side (+X side) is connected to an end of the motor housing portion 81 on the left side (+Y side). An end of the gear housing portion 82 on the rear side (−X side) further protrudes rearward from the motor housing portion 81.

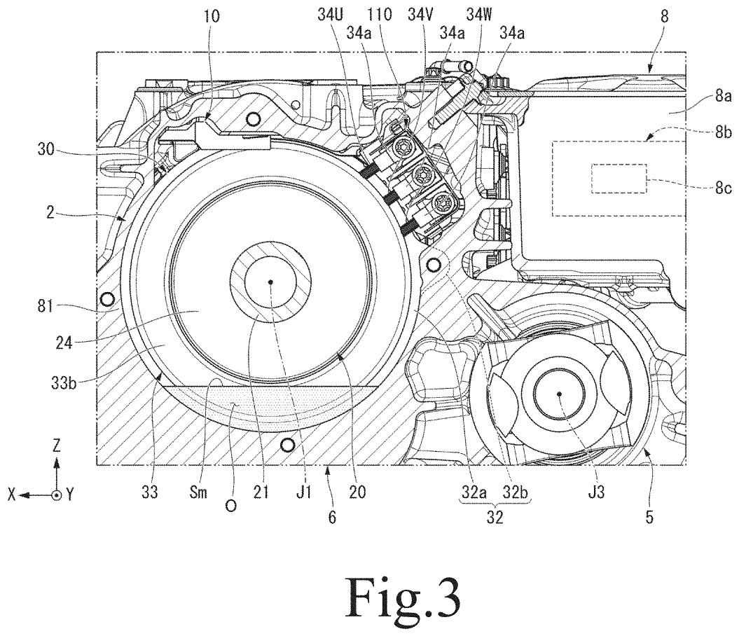

The inverter unit 8 is located on the rear side (−X side) of the motor housing portion 81. The inverter unit 8 has a substantially rectangular parallelepiped shape elongated in the axial direction. An end of the inverter unit 8 on the left side (+Y side) is located above a portion of the gear housing portion 82 protruding rearward from the motor housing portion 81. As illustrated in FIG. 3, the inverter unit 8 is located on the rear side of the rotating electric machine 2. The inverter unit 8 includes an inverter case 8a and a control unit 8b.

The inverter case 8a has a substantially rectangular parallelepiped box shape elongated in the axial direction. The inverter case 8a is attached to a wall portion of the motor housing portion 81 on the rear side (−X side) with, for example, a screw. The control unit 8b controls the rotating electric machine 2 and an oil pump 96 to be described later. More specifically, the control unit 8b controls the rotating electric machine 2 and the oil pump 96 based on a detection result of a temperature detection unit 70 to be described later. The control unit 8b is housed inside the inverter case 8a. The control unit 8b includes an inverter 8c that supplies power to the rotating electric machine 2. That is, the inverter unit 8 includes the inverter 8c.

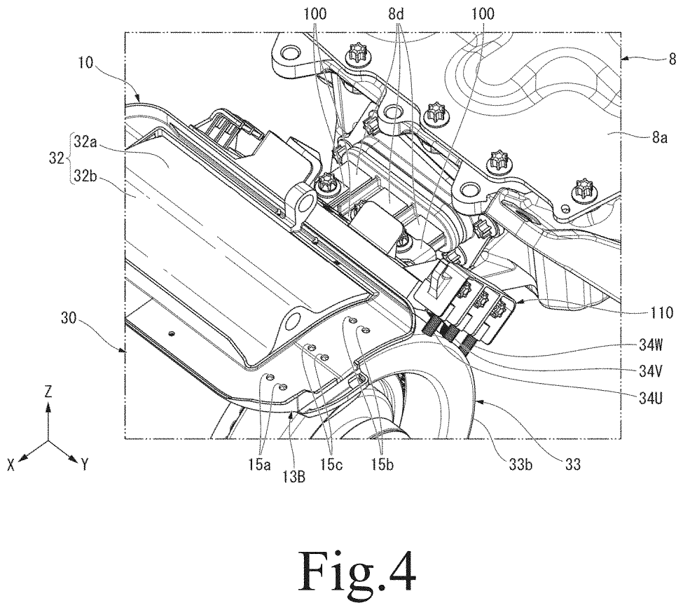

As illustrated in FIG. 4, the inverter unit 8 includes a second busbar 8d protruding forward from a wall portion of the inverter case 8a on the front side (+X side). The second busbar 8d penetrates the front wall portion of the inverter case 8a in the front-rear direction. A portion of the second busbar 8d located inside the inverter case 8a is electrically connected to the inverter 8c although not illustrated. For example, three second busbars 8d are provided. The three second busbars 8d are arranged side by side at intervals in the left-right direction.

The rotating electric machine 2 in the present embodiment is an inner-rotor motor. As illustrated in FIG. 1, the rotating electric machine 2 includes the rotor 20, the stator 30, and bearings 26 and 27. The rotor 20 is capable of rotating about the central axis J1, which extends in the horizontal direction orthogonal to the vertical direction. Torque of the rotor 20 is transmitted to the transmission 3. The rotor 20 includes a shaft 21 and a rotor body 24. The rotor body 24 includes a rotor core and a rotor magnet fixed to the rotor core although not illustrated.

As illustrated in FIG. 3, a lower end of the rotor body 24 is located above an oil level Sm of the oil O contained inside the motor housing portion 81. Therefore, it is possible to suppress the oil O contained inside the motor housing portion 81 from becoming a resistance when the rotor 20 rotates. The lower end of the rotor body 24 is a lower end of the rotor 20.

As illustrated in FIG. 1, the shaft 21 extends in the axial direction with the central axis J1 as a center. The shaft 21 rotates about the central axis J1. The shaft 21 is a hollow shaft provided with a hollow portion 22 therein. The shaft 21 is provided with a communicating hole 23. The communicating hole 23 extends in the radial direction to connect the hollow portion 22 with the outside of the shaft 21.

The shaft 21 extends across the motor housing portion 81 and the gear housing portion 82 of the housing 6. An end of the shaft 21 on the left side (+Y side) protrudes to the inside of the gear housing portion 82. A first gear 41, which will be described later, of the transmission 3 is fixed to the left end of the shaft 21. The shaft 21 is rotatably supported by the bearings 26 and 27.

The stator 30 faces the rotor 20 in the radial direction with a gap interposed therebetween. More specifically, the stator 30 is located radially outside of the rotor 20. The stator 30 surrounds the rotor 20. The stator 30 includes a stator core 32 and a coil assembly 33. The stator core 32 is fixed to an inner peripheral surface of the motor housing portion 81. As illustrated in FIGS. 3 to 6, the stator core 32 includes a stator core body 32a and a fixing portion 32b. The stator core body 32a includes a cylindrical core back extending in the axial direction and a plurality of teeth extending radially inward from the core back although not illustrated.

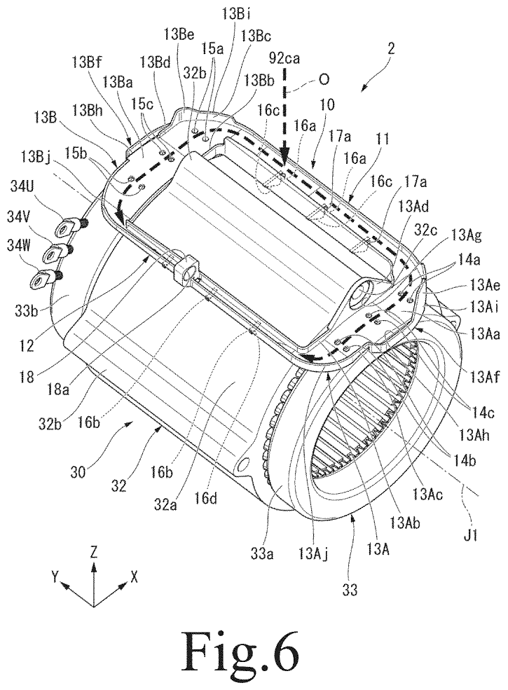

The fixing portion 32b protrudes radially outward from an outer peripheral surface of the stator core body 32a. The fixing portion 32b is a portion fixed to the motor housing portion 81. As illustrated in FIG. 6, a plurality of the fixing portions 32b are provided with an interval in the circumferential direction. One of the fixing portions 32b protrudes upward from the stator core body 32a. The other one of the fixing portions 32b protrudes to the rear side (−X side) from the stator core body 32a. The fixing portion 32b includes a through hole 32c penetrating the fixing portion 32b in the axial direction. The stator 30 is fixed to the housing 6 by tightening a screw passing through the through hole 32c into the motor housing portion 81 although not illustrated.

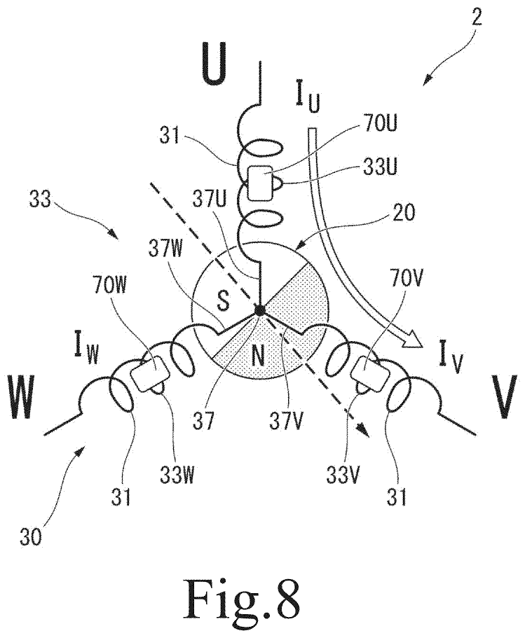

As illustrated in FIG. 1, the coil assembly 33 is held by the stator core 32. The coil assembly 33 includes a plurality of coils 31 attached to the stator core 32 in the circumferential direction. The plurality of coils 31 are mounted to the respective teeth of the stator core 32 with an insulator (not illustrated) interposed therebetween. The plurality of coils 31 are arranged in the circumferential direction. More specifically, the plurality of coils 31 are arranged at equal intervals over one circumference in the circumferential direction. The plurality of coils 31 in the present embodiment are star-connected to form an AC circuit having a plurality of phases as schematically illustrated in FIG. 8. The plurality of coils 31 form, for example, a three-phase AC circuit including a U phase, a V phase, and a W phase.

As illustrated in FIG. 1, the coil assembly 33 includes coil ends 33a and 33b protruding axially from the stator core 32. The coil end 33a is a portion that protrudes to the right side (−Y side) from the stator core 32. The coil end 33b is a portion that protrudes to the left side (+Y side) from the stator core 32. The coil end 33a is formed of a portion of each of the coils 31, included in the coil assembly 33, which protrudes to the right side from the stator core 32. The coil end 33b is formed of a portion of each of the coils 31, included in the coil assembly 33, which protrudes to the left side from the stator core 32. The coil ends 33a and 33b are annular about the central axis J1 in the present embodiment.

As illustrated in FIG. 7, the coil end 33b includes at least three coil crossover portions 33U, 33V, and 33W having mutually different phases. The coil crossover portions 33U, 33V, and 33W extend in the circumferential direction. The coil crossover portions 33U, 33V, and 33W are arranged side by side in the circumferential direction. In FIG. 7, the coil crossover portion 33U and the coil crossover portion 33V are located at a radially outer end of the coil end 33b, and the coil crossover portion 33W is located at a radially inner end of the coil end 33b. The coil crossover portion 33U and the coil crossover portion 33W partially overlap with each other when viewed from the radial direction. The coil crossover portion 33V and the coil crossover portion 33W partially overlap with each other when viewed from the radial direction. A plurality of the coil crossover portions 33U, a plurality of the coil crossover portions 33V, and a plurality of the coil crossover portions 33W are provided in the circumferential direction although not particularly illustrated.

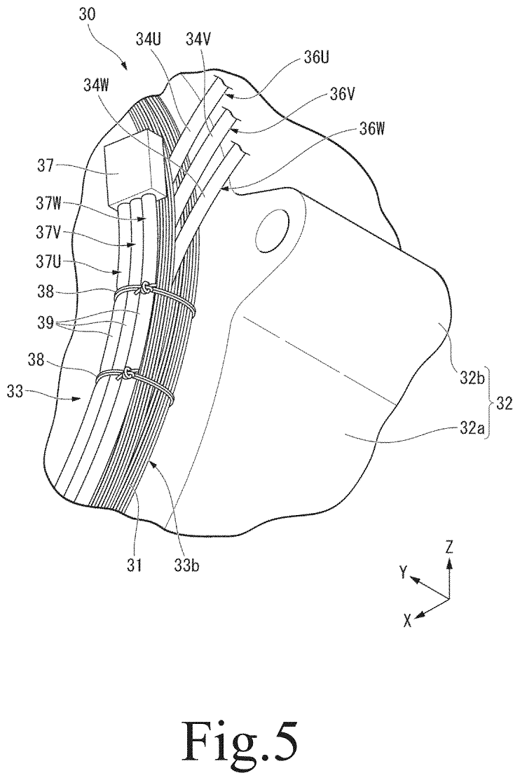

As illustrated in FIG. 5, the coil assembly 33 includes coil lead wires 36U, 36V, 36W, 37U, 37V, and 37W, neutral point members 37, and binding members 38. A plurality of the coil lead wires 36U, a plurality of the coil lead wires 36V, a plurality of the coil lead wires 36W, a plurality of the coil lead wires 37U, a plurality of the coil lead wires 37V, and a plurality of the coil lead wires 37W are provided in the coil assembly 33. The coil lead wires 36U, 36V, 36W, 37U, 37V, and 37W are drawn out from the coil 31. Each of the coil lead wires 36U, 36V, 36W, 37U, 37V, and 37W is a part of the conducting wire constituting the coil 31 in the present embodiment. Each of the coil lead wires 36U, 36V, 36W, 37U, 37V, and 37W is covered with an insulating tube 39 and is wound on the coil end 33b.

The coil lead wires 36U, 36V, and 36W are coil lead wires electrically connected to the inverter 8c via first busbars 100 to be described later, and the second busbars 8d. AC currents having different phases flow from the inverter 8c to the coil lead wire 36U, the coil lead wire 36V, and the coil lead wire 36W. A distal end of the coil lead wire 36U is a terminal portion 34U. A distal end of the coil lead wire 36V is a terminal portion 34V. A distal end of the coil lead wire 36W is a terminal portion 34W. That is, the coil assembly 33 includes the terminal portions 34U, 34V, and 34W.

The terminal portions 34U, 34V, and 34W protrude radially outward from the coil end 33b. The terminal portions 34U, 34V, and 34W protrude obliquely upward on the rear side (−X side) from the coil end 33b in the present embodiment. As illustrated in FIG. 3, the terminal portions 34U, 34V, and 34W are located on the rear side (−X side) of the central axis J1 in the front-rear direction. The terminal portions 34U, 34V, and 34W are located above the central axis J1. The terminal portion 34U, the terminal portion 34V, and the terminal portion 34W are arranged side by side at intervals in the circumferential direction. The terminal portion 34U, the terminal portion 34V, and the terminal portion 34W are electrically connected to the inverter 8c via the first busbars 100 to be described later and the second busbars 8d. Crimp terminals 34a are each provided at distal ends of the terminal portions 34U, 34V, and 34W. The terminal portions 34U, 34V, and 34W are electrically connected to the first busbars 100 via the crimp terminals 34a.

As illustrated in FIGS. 5 and 8, the coil lead wires 37U, 37V, and 37W are coil lead wires whose distal ends are connected to each other via the neutral point member 37. The neutral point member 37, as a neutral point, electrically connects the distal end of the coil lead wire 37U, the distal end of the coil lead wire 37V, and the distal end of the coil lead wire 37W. That is, the neutral point member 37 electrically connects the ends of the plurality of coil lead wires 37U, 37V, 37W to each other. As illustrated in FIG. 5, the coil lead wires 37U, 37V, and 37W and the neutral point member 37 are wound in the circumferential direction on a surface of the coil end 33b facing the left side (+Y side). That is, the coil lead wires 37U, 37V, and 37W and the neutral point member 37 are arranged at on coil end 33b. At least one of the neutral point members 37 is provided in the coil assembly 33. In the present embodiment, four neutral point members 37 are provided on the coil end 33b at equal pitches in the circumferential direction although not particularly illustrated. That is, a plurality of sets of the coil lead wires 37U, 37V, and 37W and the neutral point member 37 are provided.

At least one of the plurality of neutral point members 37 is arranged in a portion of the coil end 33b located above the central axis J1. The neutral point member 37 illustrated in FIG. 7 is arranged at an upper end of the coil end 33b. The neutral point member 37 is arranged between the coil crossover portion 33U and the coil crossover portion 33V in the circumferential direction when viewed from the axial direction. The neutral point member 37 is arranged radially outside the coil crossover portion 33W when viewed from the axial direction.

As illustrated in FIG. 5, the binding member 38 is an annular member that collectively binds the coil lead wires 36U, 36V, 36W, 37U, 37V, and 37W covered with the insulating tube 39 and the coil end 33b. The binding member 38 may further bind the neutral point member 37. The plurality of binding members 38 are provided. FIG. 5 illustrates two binding members 38 that bind the coil lead wires 37U, 37V, and 37W and the coil end 33b. The binding member 38 may be, for example, a string or a plastic band. A part of the coil assembly 33 bound by the binding member 38 is integrally fixed with varnish or the like.

As illustrated in FIG. 1, the bearings 26 and 27 rotatably support the rotor 20. Each of the bearings 26 and 27 is, for example, a ball bearing. The bearing 26 is a bearing that rotatably supports a portion of the rotor 20 located on the right side (−Y side) of the stator core 32. The bearing 26 supports a portion of the shaft 21 located on the right side of a portion of the shaft to which the rotor body 24 is fixed in the present embodiment. The bearing 26 is held by a wall portion of the motor housing portion 81 that covers the right side of the rotor 20 and the stator 30.

The bearing 27 is a bearing that rotatably supports a portion of the rotor 20 located on the left side (+Y side) of the stator core 32. The bearing 27 supports a portion of the shaft 21 located on the left side of the portion of the shaft to which the rotor body 24 is fixed in the present embodiment. The bearing 27 is held by the partition wall 61c.

As illustrated in FIGS. 4 and 7, the rotating electric machine 2 includes the first busbars 100, a terminal block 110, a refrigerant supply unit 10, and a temperature detection unit 70. That is, the drive apparatus 1 includes the first busbars 100, the terminal block 110, the refrigerant supply unit 10, and the temperature detection unit 70. The first busbars 100 are busbars to which the terminal portions 34U, 34V, and 34W are connected. For example, three first busbars 100 are provided in the present embodiment. One ends of the three first busbars 100 are each connected to the terminal portions 34U, 34V, and 34W. The other ends of the three first busbars 100 are each connected to portions of the three second busbars 8d protruding outward from the inverter case 8a.

The terminal block 110 is a member that holds the first busbar 100. The terminal block 110 extends in the axial direction. The terminal block 110 is supported by portions of the outer peripheral surface of the stator core body 32a on the rear side (−X side) and the upper side in the present embodiment. The first busbars 100 and the terminal block 110 are provided in a portion, located between the stator 30 and the inverter unit 8 in the front-rear direction, inside the motor housing portion 81 in the present embodiment. The refrigerant supply unit 10 and the temperature detection unit 70 will be described later.

As illustrated in FIG. 1, the transmission 3 is housed in the gear housing portion 82 of the housing 6. The transmission 3 is connected to the rotating electric machine 2. More specifically, the transmission 3 is connected to the left end of the shaft 21. The transmission 3 includes the reduction gear 4 and the differential gear 5. Torque output from the rotating electric machine 2 is transmitted to the differential gear 5 via the reduction gear 4.

The reduction gear 4 is connected to the rotating electric machine 2. The reduction gear 4 increases the torque output from the rotating electric machine 2 in accordance with a reduction ratio while reducing a rotation speed of the rotating electric machine 2. The reduction gear 4 transmits the torque output from the rotating electric machine 2 to the differential gear 5. The reduction gear 4 includes the first gear 41, a second gear 42, a third gear 43, and an intermediate shaft 45.

The first gear 41 is fixed to an outer peripheral surface of the end of the shaft 21 on the left side (+Y side). The first gear 41 rotates about the central axis J1 together with the shaft 21. The intermediate shaft 45 extends along an intermediate axis J2 parallel to the central axis J1. The intermediate shaft 45 rotates about the intermediate axis J2. The second gear 42 and the third gear 43 are fixed to an outer peripheral surface of the intermediate shaft 45. The second gear 42 and the third gear 43 are connected via the intermediate shaft 45. The second gear 42 and the third gear 43 rotate about the intermediate axis J2. The second gear 42 meshes with the first gear 41. The third gear 43 meshes with a ring gear 51, which will be described later, of the differential gear 5.

The torque output from the rotating electric machine 2 is transmitted to the ring gear 51 of the differential gear 5 via the shaft 21, the first gear 41, the second gear 42, the intermediate shaft 45, and the third gear 43 in this order. A gear ratio of each gear, the number of gears, and the like can be modified in various manners in accordance with a required reduction ratio. In the present embodiment, the reduction gear 4 is a speed reducer of a parallel-axis gearing type in which center axes of gears are arranged in parallel with each other.

The differential gear 5 is connected to the rotating electric machine 2 via the reduction gear 4. The differential gear 5 is a device configured to transmit the torque output from the rotating electric machine 2 to wheels of the vehicle. The differential gear 5 transfers the same torque to the axle 55 of left and right wheels while absorbing a difference in speed between the left and right wheels when the vehicle turns. The differential gear 5 includes the ring gear 51, a gear housing (not illustrated), a pair of pinion gears (not illustrated), a pinion shaft (not illustrated), and a pair of side gears (not illustrated). The ring gear 51 rotates about a differential axis J3 parallel to the central axis J1. The torque output from the rotating electric machine 2 is transferred to the ring gear 51 via the reduction gear 4.

A lower end of the ring gear 51 is located below the oil level Sg of the oil pool P in the gear housing portion 82. As a result, the lower end of the ring gear 51 is immersed in the oil O in the gear housing portion 82. The oil level Sg of the oil pool P is located below the differential axis J3 and the axle 55 in the present embodiment.

The drive apparatus 1 is provided with the oil passage 90 through which the oil O circulates inside the housing 6. The oil passage 90 is a channel of the oil O along which the oil O is fed from the oil pool P to the rotating electric machine 2 and is led back to the oil pool P. The oil passage 90 is provided across the inside of the motor housing portion 81 and the inside of the gear housing portion 82.

Note that the “oil passage” in the present specification refers to a channel of oil (refrigerant). Therefore, the “oil passage” is a concept that includes not only a “flow passage” that constantly generates a flow of oil flowing in one direction but also a channel for temporarily retaining oil and a channel for oil to drip. The channel for temporarily retaining oil includes, for example, a reservoir for storing oil.

The oil passage 90 includes a first oil passage 91 and a second oil passage 92. Each of the first oil passage 91 and the second oil passage 92 circulates the oil O inside the housing 6. The first oil passage 91 includes a scraping-up channel 91a, a shaft feed channel 91b, an intra-shaft channel 91c, and an intra-rotor channel 91d. In addition, a reservoir 93 is arranged in the channel of the first oil passage 91. The reservoir 93 is provided inside the gear housing portion 82.

The scraping-up channel 91a is a channel along which the oil O is scraped up from the oil pool P by rotation of the ring gear 51 of the differential gear 5 to be received by the reservoir 93. The reservoir 93 opens upward. The reservoir 93 receives the oil O scraped up by the ring gear 51. In addition, the reservoir 93 also receives the oil O scraped up by the second gear 42 and the third gear 43 in addition to the ring gear 51 when the oil level Sg of the oil pool P is high immediately after the rotating electric machine 2 is driven.

The shaft feed channel 91b guides the oil O from the reservoir 93 into the hollow portion 22 of the shaft 21. The intra-shaft channel 91c is a channel along which the oil O passes inside the hollow portion 22 of the shaft 21. The intra-rotor channel 91d is a channel along which the oil O passes through the inside of the rotor body 24 from the communicating hole 23 of the shaft 21 and scatters to the stator 30.

In the intra-shaft channel 91c, a centrifugal force is applied to the oil O inside the rotor 20 as the rotor 20 rotates. As a result, the oil O is continuously scattered radially outward from the rotor 20. In addition, the scattering of the oil O generates a negative pressure in a channel inside the rotor 20, so that the oil O accumulated in the reservoir 93 is sucked into the rotor 20 to fill channel inside the rotor 20 with the oil O.

The oil O having reached the stator 30 absorbs heat from the stator 30. The oil O having cooled the stator 30 drips to the lower side, and is accumulated in a lower region in the motor housing portion 81. The oil O having accumulated in the lower region in the motor housing portion 81 moves to the gear housing portion 82 through the partition wall opening 68 provided in the partition wall 61c. As described above, the first oil passage 91 is used to supply the oil O to the rotor 20 and the stator 30.

In the second oil passage 92, the oil O is raised from the oil pool P to the upper side of the stator 30 to be supplied to the stator 30. That is, the drive apparatus 1 includes the second oil passage 92 as an oil passage for supplying the oil O to the stator 30 from above in the present embodiment. The second oil passage 92 is provided with the oil pump 96, a cooler 97, and the refrigerant supply unit 10. The second oil passage 92 includes a first flow passage 92a, a second flow passage 92b, and a third flow passage 92c.

The first flow passage 92a, the second flow passage 92b, and the third flow passage 92c are provided in the wall portion of the housing 6. The first flow passage 92a connects the oil pool P and the oil pump 96. The second flow passage 92b connects the oil pump 96 and the cooler 97. The third flow passage 92c extends upward from the cooler 97. The third flow passage 92c is provided in a wall portion of the motor housing portion 81. As illustrated in FIG. 6, the third flow passage 92c includes a supply port 92ca open to the inside of the motor housing portion 81 above the stator 30. The supply port 92ca supplies the oil O to the inside of the motor housing portion 81.

The oil pump 96 is an electric pump driven by electricity. As illustrated in FIG. 1, the oil pump 96 sucks up the oil O from the oil pool P via the first flow passage 92a, and supplies the oil O to the rotating electric machine 2 via the second flow passage 92b, the cooler 97, the third flow passage 92c, and the refrigerant supply unit 10.

The cooler 97 cools the oil O passing through the second oil passage 92. The second flow passage 92b and the third flow passage 92c are connected to the cooler 97. The second flow passage 92b and the third flow passage 92c are connected to each other through an internal flow passage of the cooler 97. A cooling water pipe 97j for causing cooling water cooled by a radiator (not illustrated) to pass is connected to the cooler 97. The oil O passing through the inside of the cooler 97 is cooled by heat exchange with the cooling water passing through the cooling water pipe 97j. Note that the inverter unit 8 is provided in a channel of the cooling water pipe 97j. The cooling water passing through the cooling water pipe 97j cools the inverter unit 8.

The refrigerant supply unit 10 forms a part of the second oil passage 92. The refrigerant supply unit 10 is located inside the motor housing portion 81. The refrigerant supply unit 10 is located above the stator 30. As illustrated in FIG. 6, the refrigerant supply unit 10 is supported by the stator 30 from below and is provided in the rotating electric machine 2. The refrigerant supply unit 10 is made of, for example, a resin material. The refrigerant supply unit 10 supplies the oil O circulating inside the housing 6 to the stator 30.

In the following description, for an object, the side closer to the center of the stator 30 in the axial direction may be referred to as an “axially inner side”, and the side away from the center of the stator 30 in the axial direction may be referred to as an “axially outer side”.

The refrigerant supply unit 10 has a gutter shape that opens upward and extends in a substantially rectangular frame shape when viewed in the vertical direction in the present embodiment. That is, the refrigerant supply unit 10 of the present embodiment is a reservoir. The refrigerant supply unit 10 stores the oil O. The refrigerant supply unit 10 stores the oil O supplied inside the motor housing portion 81 via the third flow passage 92c in the present embodiment. That is, the third flow passage 92c corresponds to a supply oil passage that supplies the oil O to the refrigerant supply unit 10 in the present embodiment. Since the refrigerant supply unit 10 has the gutter shape that opens upward in the present embodiment, the oil O can be easily supplied to the refrigerant supply unit 10 by allowing the oil O to flow out of the third flow passage 92c above the refrigerant supply unit 10. As illustrated in FIG. 6, the refrigerant supply unit 10 includes a first oil passage portion 11, a second oil passage portion 12, a pair of third oil passage portions 13A and 13B, a first fixing portion 18, and support ribs 16a and 16b. Each of the first oil passage portion 11, the second oil passage portion 12, and the pair of third oil passage portions 13A and 13B forms a part of a flow passage of the refrigerant supply unit 10, that is, a flow passage portion. The first oil passage portion 11, the second oil passage portion 12, and the pair of third oil passage portions 13A and 13B are located radially outside the stator 30. That is, the refrigerant supply unit 10 has the flow passage portions which are arranged on the radially outer side with respect to the stator 30 and through which the oil O passes.

The first oil passage portion 11 and the second oil passage portion 12 extend in the axial direction. The first oil passage portion 11 and the second oil passage portion 12 are arranged with an interval in the front-rear direction. The second oil passage portion 12 and the first oil passage portion 11 sandwich the central axis J1 when viewed in the vertical direction. The first oil passage portion 11 is located on the front side of the central axis J1. The second oil passage portion 12 is located on the rear side of the central axis J1.

The pair of third oil passage portions 13A and 13B extends in the front-rear direction. The pair of third oil passage portions 13A and 13B is arranged with an interval in the axial direction. The pair of third oil passage portions 13A and 13B connects the first oil passage portion 11 and the second oil passage portion 12. In the present embodiment, one third oil passage portion 13A of the pair of third oil passage portions 13A and 13B connects a right end of the first oil passage portion 11 and a right end of the second oil passage portion 12. In the present embodiment, the other third oil passage portion 13B of the pair of third oil passage portions 13A and 13B connects a left end of the first oil passage portion 11 and a left end of the second oil passage portion 12. Each of the first oil passage portion 11, the second oil passage portion 12, and the pair of third oil passage portions 13A and 13B has a substantially U-shaped gutter-like cross section that opens upward.

The first oil passage portion 11 is located above the stator core 32. The first oil passage portion 11 is located on the front side of the fixing portion 32b on the upper side that protrudes upward from the outer peripheral surface of the stator core body 32a among the plurality of fixing portions 32b in the present embodiment.

The first oil passage portion 11 is located below the supply port 92ca. As a result, the first oil passage portion 11 receives the oil O supplied into the motor housing portion 81 from the supply port 92ca. That is, the third flow passage 92c as the supply oil passage supplies the oil O to a portion of the refrigerant supply unit 10 located on the front side (+X side) of the central axis J1. The supply port 92ca is arranged at a position on the radially inner side away from both ends of the first oil passage portion 11 in the axial direction in the present embodiment.

The first oil passage portion 11 includes a first oil supply port 17a for supplying the oil O to the stator 30 from above. That is, the refrigerant supply unit 10 includes the first oil supply port 17a. In the present embodiment, the first oil supply port 17a is a through hole that penetrates a portion of a bottom wall of the refrigerant supply unit 10 located in the first oil passage portion 11 in the vertical direction. The first oil supply port 17a has, for example, a circular shape. The first oil supply port 17a is located above the stator 30. More specifically, the first oil supply port 17a is located above the stator core 32 at a distance. The first oil supply port 17a opens toward the stator core 32. Some of the oil O supplied to the first oil passage portion 11 flows out below the first oil passage portion 11 through the first oil supply port 17a, and is supplied to the stator core 32 from above. In this manner, the first oil supply port 17a supplies the oil O to the stator core 32 from above in the present embodiment.

In the present embodiment, a plurality of the first oil supply ports 17a are provided in the axial direction which is a direction in which the first oil passage portion 11 extends. In the present embodiment, for example, three first oil supply ports 17a are provided.

The second oil passage portion 12 is located above the stator core 32. The second oil passage portion 12 is located on the rear side of the fixing portion 32b on the upper side in the present embodiment. Therefore, the first oil passage portion 11 and the second oil passage portion 12 are arranged to sandwich the fixing portion 32b on the upper side in the front-rear direction. The dimension of the second oil passage portion 12 in the front-rear direction is smaller than the dimension of the first oil passage portion 11 in the front-rear direction. A lower end of the second oil passage portion 12 is located lower than a lower end of the first oil passage portion 11.

The second oil passage portion 12 is provided with the first fixing portion 18. The first fixing portion 18 is provided at a left portion of the second oil passage portion 12 relative to the center in the axial direction. The first fixing portion 18 protrudes upward from the second oil passage portion 12. A rear end of the first fixing portion 18 protrudes rearward from the second oil passage portion 12. The first fixing portion 18 has a substantially rectangular parallelepiped shape in the present embodiment. The first fixing portion 18 includes a through hole 18a that penetrates the first fixing portion 18 in the axial direction. Although not illustrated, a screw to be tightened into the motor housing portion 81 passes through the through hole 18a. The first fixing portion 18 is fixed to the housing 6 by the screw passing through the through hole 18a. Note that a cylindrical metal member that opens on both sides in the axial direction may be embedded in the through hole 18a. In this case, the screw fixing the first fixing portion 18 passes through the metal member.

The second oil passage portion 12 has a second oil supply port (not illustrated) for supplying the oil O to the stator 30 from above. That is, the refrigerant supply unit 10 has the second oil supply port. In the present embodiment, the second oil supply port is a through hole that penetrates a portion of the bottom wall of the refrigerant supply unit 10 located in the second oil passage portion 12 in the vertical direction. The second oil supply port has, for example, a circular shape or a rectangular shape.

The second oil supply port is located above the stator 30. More specifically, the second oil supply port is located above the stator core 32. The second oil supply port opens toward the stator core 32. At least some of the oil O supplied to the second oil passage portion 12 flows out below the second oil passage portion 12 through the second oil supply port, and is supplied to the stator core 32 from above. In this manner, the second oil supply port supplies the oil O to the stator core 32 from above in the present embodiment.

In the present embodiment, a plurality of the second oil supply ports are provided in the axial direction which is a direction in which the second oil passage portion 12 extends. In the present embodiment, for example, six second oil supply ports are provided.

The third oil passage portion 13A is located on the right side of the stator core 32. The third oil passage portion 13A is located above the coil end 33a. The third oil passage portion 13B is located on the left side of the stator core 32. The third oil passage portion 13B is located above the coil end 33b. The third oil passage portion 13A and the third oil passage portion 13B have substantially the same configuration except that the both are arranged substantially symmetrically in the axial direction in the present embodiment. Therefore, only the third oil passage portion 13A may be described as a representative of the third oil passage portion 13A and the third oil passage portion 13B in the following description.

The third oil passage portion 13A includes a bottom wall portion 13Aa and a pair of side wall portions 13Ab and 13Ac. The bottom wall portion 13Aa extends in the front-rear direction. The bottom wall portion 13Aa has a plate shape with the plate face oriented in the vertical direction. A front end of the bottom wall portion 13Aa is connected to the right end of the first oil passage portion 11. A rear end of the bottom wall portion 13Aa is connected to the right end of the second oil passage portion 12. A central portion of the bottom wall portion 13Aa in the front-rear direction is curved in an arc shape that protrudes upward along an outer peripheral surface above the coil end 33a when viewed from the axial direction. The rear end of the bottom wall portion 13Aa is located lower than the front end of the bottom wall portion 13Aa.

The side wall portion 13Ab protrudes upward from an axially inner (left) edge of the bottom wall portion 13Aa. The side wall portion 13Ac protrudes upward from an axially outer (right side) edge of the bottom wall portion 13Aa. The pair of side wall portions 13Ab and 13Ac extends in the front-rear direction. The pair of side wall portions 13Ab and 13Ac has a plate shape with the plate face oriented in the axial direction. A front end of the side wall portion 13Ab is connected to the right end of the first oil passage portion 11. A rear end of the side wall portion 13Ab is connected to the right end of the second oil passage portion 12.

The side wall portion 13Ab includes a second fixing portion 13Ad in a central portion in the front-rear direction. The second fixing portion 13Ad protrudes upward. The second fixing portion 13Ad includes a through hole 13Ag that penetrates the second fixing portion 13Ad in the axial direction. The through hole 13Ag overlaps with the through hole 32c of the fixing portion 32b on the upper side when viewed in the axial direction. The through hole 32c and the through hole 13Ag are arranged concentrically. The inner diameter of the through hole 13Ag is larger than the inner diameter of the through hole 32c.

Although not illustrated, the second fixing portion 13Ad includes a metal member embedded in the through hole 13Ag. The metal member is a cylindrical member that opens on both sides in the axial direction. A screw for fixing the stator core 32 to the motor housing portion 81 passes through the inside of the metal member and the through hole 13Ag from the right side. The screw for fixing the stator core 32 to the motor housing portion 81 fastens and fixes the second fixing portion 13Ad to the motor housing portion 81 together with the stator core 32. In this manner, the refrigerant supply unit 10 is fixed to the housing 6 as the first fixing portion 18 and the second fixing portion 13Ad are screwed to the motor housing portion 81 in the present embodiment. As a result, the refrigerant supply unit 10 can be firmly fixed.

A front end of the side wall portion 13Ac is connected to the right end of the first oil passage portion 11. A rear end of the side wall portion 13Ac is connected to the right end of the second oil passage portion 12. The front end of the side wall portion 13Ac is a curved portion 13Ai that is curved toward and is smoothly connected to the first oil passage portion 11. The rear end of the side wall portion 13Ac is a curved portion 13Aj that is curved toward and is smoothly connected to the second oil passage portion 12. The curved portions 13Ai and 13Aj are curved in an arc shape with a uniform radius of curvature when viewed in the vertical direction in the present embodiment.

The curved portion 13Ai includes a protrusion 13Ae protruding upward. Although not illustrated, an upper end of the protrusion 13Ae is in contact with, for example, an upper surface out of an inner wall surface of the motor housing portion 81. As a result, the oil O flowing into the third oil passage portion 13A can be prevented from flowing over the curved portion 13Ai, and the oil O can be prevented from leaking from the third oil passage portion 13A.

The third oil passage portion 13A has third oil supply ports 14a, 14b, and 14c for supplying the oil O to the stator 30 from above. A plurality of the third oil supply ports 14a, a plurality of the third oil supply ports 14b, and a plurality of the third oil supply ports 14c are provided side by side in the front-rear direction. In the present embodiment, the third oil supply ports 14a, 14b, and 14c are through holes penetrating the bottom wall portion 13Aa in the vertical direction. The third oil supply ports 14a, 14b, and 14c have, for example, a circular shape. The third oil supply ports 14a, 14b, and 14c are located above the stator 30. More specifically, the third oil supply ports 14a, 14b, and 14c are located above the coil end 33a. Some of the oil O supplied to the third oil passage portion 13A flows out below the third oil passage portion 13A through the third oil supply ports 14a, 14b, and 14c, and is supplied to the coil end 33a from above. In this manner, the third oil supply ports 14a, 14b, and 14c supply the oil O to the coil end 33a from above in the present embodiment.

In the present embodiment, a plurality of the third oil supply ports 14a, a plurality of the third oil supply ports 14b, and a plurality of the third oil supply ports 14c are provided side by side in the axial direction. In the present embodiment, a total of six third oil supply ports 14a, 14b, and 14c are provided with two each. Specifically, among the third oil supply ports 14a, 14b, and 14c, the third oil supply port 14a is arranged at a front portion of the bottom wall portion 13Aa, the third oil supply port 14b is arranged at a rear portion of the bottom wall portion 13Aa, and the third oil supply port 14c is arranged at a central portion of the bottom wall portion 13Aa in the front-rear direction.

The third oil passage portion 13A includes a bearing oil supply unit 13Af that protrudes to the axially outer side (right side). The bearing oil supply unit 13Af is located at in a central portion of the third oil passage portion 13A in the front-rear direction. The bearing oil supply unit 13Af is located above the bearing 26. The bearing oil supply unit 13Af includes a recessed groove portion 13Ah and a bearing oil supply port (not illustrated). That is, the refrigerant supply unit 10 includes the recessed groove portion 13Ah and the bearing oil supply port. The recessed groove portion 13Ah is provided on an axially outer edge of an upper surface of the bottom wall portion 13Aa. The recessed groove portion 13Ah is recessed downward and extends in the front-rear direction. The bearing oil supply port is provided on a groove bottom surface of the recessed groove portion 13Ah. The bearing oil supply port is a through hole penetrating the bottom wall portion 13Aa in the vertical direction. The bearing oil supply port is located above the bearing 26. The bearing oil supply port supplies the oil O in the recessed groove portion 13Ah to the bearing 26 from above. Therefore, the oil O can be supplied to the bearing 26 via the refrigerant supply unit 10 as lubricating oil.

The third oil passage portion 13B has a bottom wall portion 13Ba and a pair of side wall portions 13Bb and 13Bc. The side wall portion 13Bb does not include the second fixing portion 13Ad, which is different from the side wall portion 13Ab. A front end of the side wall portion 13Bc is a curved portion 13Bi that is curved toward and is smoothly connected to the first oil passage portion 11. A rear end of the side wall portion 13Bc is a curved portion 13Bj that is curved toward and is smoothly connected to the second oil passage portion 12. The curved portion 13Bi includes a protrusion 13Be protruding upward. An upper end of the protrusion 13Be is located lower than the upper end of the protrusion 13Ae. Although not illustrated, an upper end of the protrusion 13Be is in contact with, for example, the upper surface out of the inner wall surface of the motor housing portion 81. As a result, the oil O flowing into the third oil passage portion 13B can be prevented from flowing over the curved portion 13Bi, and the oil O can be prevented from leaking from the third oil passage portion 13B.

The third oil passage portion 13B includes a bearing oil supply unit 13Bf. The bearing oil supply unit 13Bf includes a recessed groove portion 13Bh and a bearing oil supply port (not illustrated). The bearing oil supply port of the bearing oil supply unit 13Bf supplies the oil O to the bearing 27 from above. Therefore, the oil O can be supplied to the bearing 27 via the refrigerant supply unit 10 as lubricating oil. The third oil passage portion 13B includes a plurality of the third oil supply ports 15a, 15b, and 15c similarly to the third oil passage portion 13A. The third oil supply ports 15a, 15b, and 15c provided in the third oil passage portion 13B supply the oil O to the coil end 33b from above. The third oil supply ports 15a, 15b, and 15c of the third oil passage portion 13B correspond to refrigerant supply holes of the present invention. Therefore, the third oil supply ports 15a, 15b, and 15c may be referred to as the refrigerant supply holes 15a, 15b, and 15c, respectively, in the present embodiment. That is, the refrigerant supply unit 10 has the refrigerant supply holes 15a, 15b, and 15c. A plurality of the refrigerant supply holes 15a, a plurality of the refrigerant supply holes 15b, and a plurality of the refrigerant supply holes 15c are provided in the refrigerant supply unit 10.

The third oil passage portion 13B has a guide wall portion 13Bd. The guide wall portion 13Bd protrudes upward from an upper surface of the bottom wall portion 13Ba. More specifically, the guide wall portion 13Bd protrudes upward from an axially inner (right) edge of the recessed groove portion 13Bh of the upper surface of the bottom wall portion 13Ba. The guide wall portion 13Bd linearly extends rearward from the curved portion 13Bi. A rear end of the guide wall portion 13Bd is located on the front side relative to the bearing oil supply port of the bearing oil supply unit 13Bf. The guide wall portion 13Bd guides the oil flowing from the first oil passage portion 11 to the third oil passage portion 13B to the rear side.

The support rib 16a protrudes downward from a portion of the bottom wall of the refrigerant supply unit 10 located in the first oil passage portion 11. A plurality of the support ribs 16a are provided at intervals in the axial direction in the present embodiment. For example, three support ribs 16a are provided. The support rib 16a includes a support surface 16c facing downward. The support surface 16c is curved along the outer peripheral surface of the stator core body 32a and in contact with the outer peripheral surface of the stator core body 32a.

The support rib 16b protrudes downward from a portion of the bottom wall of the refrigerant supply unit 10 located in the second oil passage portion 12. A plurality of the support ribs 16b are provided at intervals in the axial direction in the present embodiment. For example, the three support ribs 16b are provided. The support rib 16b includes a support surface 16d facing downward. The support surface 16d is curved along the outer peripheral surface of the stator core body 32a and in contact with the outer peripheral surface of the stator core body 32a. As a result, the refrigerant supply unit 10 is supported above the stator core 32 via the support ribs 16a and 16b.

As indicated by the dashed arrows in FIG. 6, the oil O supplied from the third flow passage 92c to the first oil passage portion 11 via the supply port 92ca branches off on both sides of the first oil passage portion 11 in the longitudinal direction, that is, on both sides in the axial direction.

Part of the oil O supplied to the first oil passage portion 11 is supplied to the stator core 32 from above via the first oil supply port 17a. The other part of the oil O supplied to the first oil passage portion 11 flows into the third oil passage portions 13A and 13B.

Part of the oil O flowing into the third oil passage portions 13A and 13B is supplied to the coil ends 33a and 33b from above via the third oil supply ports 14a, 14b, 14c, 15a, 15b, and 15c. Another part of the oil O flowing into the third oil passage portions 13A and 13B flows into the recessed groove portions 13Ah and 13Bh, and is supplied to the bearings 26 and 27 from above via the respective bearing oil supply ports. The other part of the oil O flowing into the third oil passage portions 13A and 13B flows into the second oil passage portion 12 from both ends of the second oil passage portion 12 in the axial direction.

The oil O flowing into the second oil passage portion 12 flows to the axially inner side from each of the third oil passage portions 13A and 13B. The oil O flowing into the second oil passage portion 12 is supplied to the stator core 32 from above through the second oil supply port.

The oil O supplied from the refrigerant supply unit 10 to the stator 30 and the bearings 26 and 27 is dripped downward and accumulates in the lower region in the motor housing portion 81. The oil O having accumulated in the lower region in the motor housing portion 81 moves to the gear housing portion 82 through the partition wall opening 68 provided in the partition wall 61c. As described above, the second oil passage 92 supplies the oil O to the stator 30 and the bearings 26 and 27.

As illustrated in FIG. 7, the rotating electric machine 2 includes the temperature detection unit 70 that measures the temperature of the stator 30. The temperature detection unit 70 is, for example, a thermistor or the like. A type of the temperature detection unit 70 is not particularly limited as long as the temperature of the stator 30 can be detected. The temperature detection unit 70 has, for example, a rod shape extending in one direction. The temperature detection unit 70 is arranged in the coil end 33b and extends in the circumferential direction in the present embodiment. A detection result of the temperature detection unit 10 is sent to the control unit 8b via a cable (not illustrated) extending from the temperature detection unit 70. The cable is, for example, wound from the temperature detection unit 70 along the coil end 33b, drawn into the inverter case 8a, and connected to the control unit 8b.

In the present embodiment, for example, driving of the drive apparatus 1 is controlled based on the temperature of the stator 30 measured by the temperature detection unit 70. The control of the drive apparatus 1 based on the temperature of the stator 30 includes, for example, flow rate control of the oil O sent to the rotating electric machine 2 by the oil pump 96. For example, when the temperature of the stator 30 is higher than a predetermined temperature, the control unit 8b decreases the temperature of the rotating electric machine 2 by increasing the flow rate of the oil O sent from the oil pump 96 to the rotating electric machine 2. As a result, it is possible to suppress the temperature of the rotating electric machine 2 from becoming excessively high, and it is possible to suppress the occurrence of a defect in the drive apparatus 1.

In the present embodiment, a plurality of the temperature detection units 70 are provided in the coil end 33b. Positions of the plurality of temperature detection units 70 in the circumferential direction are different from each other. In addition, at least two temperature detection units 70 have different radial positions. In the present embodiment, the temperature detection units 70 are each arranged in the three coil crossover portions 33U, 33V, and 33W. That is, the three temperature detection units 70 are provided. The plurality of temperature detection units 70 include a temperature detection unit 70U arranged in the U-phase coil crossover portion 33U, a temperature detection unit 70V arranged in the V-phase coil crossover portion 33V, and a temperature detection unit 70W arranged in the W-phase coil crossover portion 33W. Each of the temperature detection units 70U, 70V, and 70W extends in a direction in which each of the coil crossover portions 33U, 33V, and 33W extends.

FIG. 8 is an overall configuration view schematically illustrating the rotating electric machine 2 of the present embodiment. The drive apparatus 1 according to the present embodiment can use heat generated from the coil assembly 33 of the rotating electric machine 2 to heat a vehicle interior of the vehicle or heat a battery in winter to improve performance. Specifically, when the vehicle travels for example, a ratio of an excitation current and a torque current is changed while maintaining the same output torque of the rotating electric machine 2 to increase the energy loss in the rotating electric machine 2, thereby promoting heat generation of the coil assembly 33. In addition, when the vehicle is stopped, for example, power is supplied from the inverter unit 8 to the respective coils 31 of two predetermined phases (the U phase and the V phase in FIG. 8) among the three phases according to a stop position of the rotor 20 in the circumferential direction with respect to the stator 30 to increase current values Iu and Iv, thereby promoting heat generation of the coil assembly 33 without rotating the rotor 20 as illustrated in FIG. 8.

Since the temperature detection units 70U, 70V, and 70W are arranged in the coil crossover portions 33U, 33V, and 33W of the three phases, respectively, according to the present embodiment, the temperature of the coil end 33b can be accurately measured regardless of the stop position of the rotor 20 in the circumferential direction, for example, when the heat generation of the coil assembly 33 is used when the rotating electric machine 2 is stopped. That is, since the temperature detection units 70U, 70V, and 70W are respectively arranged at positions to which the oil O is stably supplied in the U phase, V phase, and W phase, it is easy to reduce a measurement variation caused by a cooling state of each phase. In addition, the highest temperature among temperatures of the coil ends 33b can be more suitably and accurately detected since the plurality of temperature detection units 70 are provided. As a result, the control of the drive apparatus 1 by the control unit 8b can be more suitably performed. Specifically, the control unit 8b can suitably control the drive apparatus 1 based on the temperature of the stator 30 obtained with higher accuracy, for example, by adopting the detection result of the temperature detection unit 70 that has detected the highest temperature among the plurality of temperature detection units 70U, 70V, and 70W.

As illustrated in FIG. 7, the coil end 33b has a temperature detection region A. The temperature detection region A is a partial region in the circumferential direction of the coil end 33b. In the present embodiment, the temperature detection region A is arranged in the upper portion of the coil end 33b. The temperature detection region A is located below the third oil passage portion 13B. The temperature detection region A faces the third oil passage portion 13B in the vertical direction. In the present embodiment, the temperature detection region A refers to a circumferential region between the pair of temperature detection units 70U and 70V located at both ends in the circumferential direction among the plurality of temperature detection units 70. More specifically, the temperature detection region A refers to a circumferential region between an end on the one circumferential side θ1 of the temperature detection unit 70V located closest to the one circumferential side θ1 and an end on the other circumferential side θ2 of the temperature detection unit 70U located closest to the other circumferential side θ2 among the three temperature detection units 70U, 70V, and 70W. Therefore, all the three temperature detection units 70U, 70V, and 70W are arranged in the temperature detection region A. That is, the plurality of temperature detection units 70 are provided in the temperature detection region A.

At least a part of at least one neutral point member 37 among the plurality of neutral point members 37 is arranged in the temperature detection region A. In the present embodiment, the entire upper neutral point member 37 located on the uppermost side among the four neutral point members 37 is arranged in the temperature detection region A. Specifically, the upper neutral point member 37 is located in a circumferential central portion of the temperature detection region A. For example, even when current values Iu, Iv, and Iw vary in the coils 31 of the respective U phase, V phase, and W phase of the stator 30 illustrated in FIG. 8 in order to promote the heat generation of the coil assembly 33 described above, a current value flowing through the neutral point member 37 is less likely to vary. The temperature of the coil end 33b can be accurately measured since the temperature detection unit 70 is arranged in the temperature detection region A where the neutral point member 37 is located as in the present embodiment, that is, the temperature detection unit 70 is arranged in the vicinity of the neutral point member 37.

As illustrated in FIG. 7, the refrigerant supply holes 15a, 15b, and 15c of the third oil passage portion 13B open toward the temperature detection region A of the coil end 33b. According to the present embodiment, the oil O is stably supplied from the refrigerant supply unit 10 toward the temperature detection region A. Therefore, it is easy to suppress trouble that a supply state of the oil O becomes unstable due to the influence of a flow rate of the oil O or the like so that a fluctuation range of the measured temperature becomes large according to the present embodiment. Therefore, it is easy to enable more accurate temperature management using the temperature detection unit 70.

The refrigerant supply holes 15a, 15b, and 15c are formed in the third oil passage portion 13B, that is, the flow passage portion, of the refrigerant supply unit 10 arranged radially outside the stator 30. For example, the present embodiment can efficiently cool the entire coil end 33b including the temperature detection region A as compared with a case where a refrigerant supply hole is axially open toward the temperature detection region A which is different from the present embodiment. In addition, a protruding amount of the refrigerant supply unit 10 protruding from the stator 30 in the axial direction can be suppressed to be small, and the rotating electric machine 2 can be made compact in the axial direction.

In addition, the refrigerant supply holes 15a, 15b, and 15c open toward the temperature detection units 70U, 70V, and 70W, respectively. Specifically, the refrigerant supply hole 15a located on the front side (+X side) opens toward the temperature detection unit 70V located on the one circumferential side θ1. The refrigerant supply hole 15b located on the rear side (−X side) opens toward the temperature detection unit 70U located on the other circumferential side θ2. The refrigerant supply hole 15c located between the refrigerant supply holes 15a and 15b in the front-rear direction opens toward the temperature detection unit 70W located between the temperature detection units 70V and 70U in the circumferential direction. More specifically, the refrigerant supply hole 15a is located above the temperature detection unit 70V in the vertical direction. The refrigerant supply hole 15b is located above the temperature detection unit 70U in the vertical direction. The refrigerant supply hole 15c is located above the temperature detection unit 70W in the vertical direction. According to the present embodiment, the way of applying the oil O to the temperature detection units 70U, 70V, and 70W is made equal, and the temperature detection units 70U, 70V, and 70W can stably measure the temperature.

In addition, the plurality of temperature detection units 70U, 70V, and 70W are arranged to surround the neutral point member 37 when viewed from the axial direction. In the present embodiment, the distances from the respective temperature detection units 70U, 70V, and 70W to the neutral point member 31 are identical. According to the present embodiment, each of the temperature detection units 70U, 70V, and 70W can measure the temperature in the vicinity of the neutral point member 37 with a small variation.

At least a part of the temperature detection unit 70 is embedded in the coil end 33b. That is, the temperature detection unit 70 is embedded in the coil end 33b. Therefore, the temperature detection unit 70 can be easily held with respect to the coil end 33b, for example, by inserting the temperature detection unit 70 into the coil end 33b and embedding at least a part thereof. In the present embodiment, the temperature detection unit 70 is inserted into the coil end 33b and substantially entirely embedded in the coil end 33b. According to the present embodiment, the oil O is prevented from being directly applied to the temperature detection unit 70. It is possible to suppress the influence of the oil O on the measurement performed by the temperature detection unit 70.

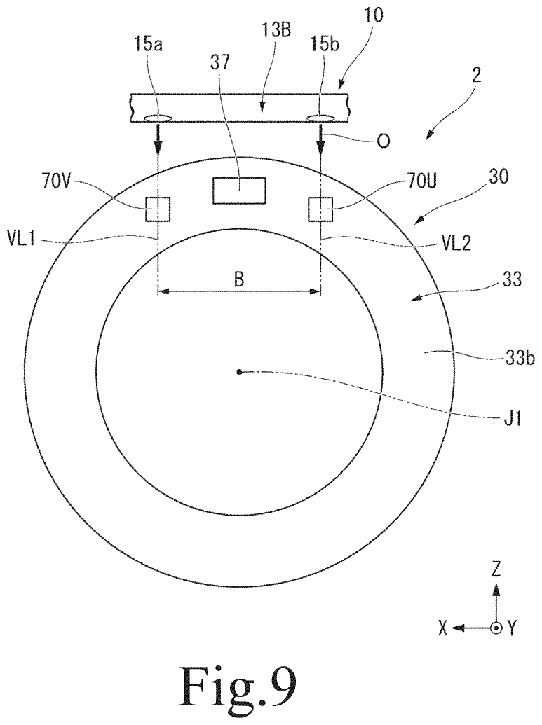

In the present embodiment, at least a part of the temperature detection units 70U and 70V and at least a part of the neutral point member 37 are arranged in a refrigerant supply region B located between a pair of virtual lines VL1 and VL2 connecting the pair of refrigerant supply holes 15a and 15b located at both ends in the circumferential direction among the plurality of refrigerant supply holes 15a, 15b, and 15c and the pair of temperature detection units 70U and 70V facing the refrigerant supply holes 15a and 15b, respectively, when viewed from the axial direction as illustrated in FIG. 9. Although not illustrated, the refrigerant supply hole 15c and the temperature detection unit 70W are also arranged in the refrigerant supply region B. According to the present embodiment, the plurality of temperature detection units 70U, 70V, and 70W are arranged in the refrigerant supply region B where the oil O is stably supplied and the neutral point member 37 is located. Therefore, the temperature in the vicinity of the neutral point member 37 can be measured with a small variation by each of the temperature detection units 70U, 70V, and 70W.

The present invention is not limited to the above-described embodiment, and the configuration or the like can be changed within a range not departing from a spirit of the present invention, for example, as will be described below. Note that the same components as those of the above-described embodiment are denoted by the same reference signs in the drawings of modifications, and differences will be mainly described below.

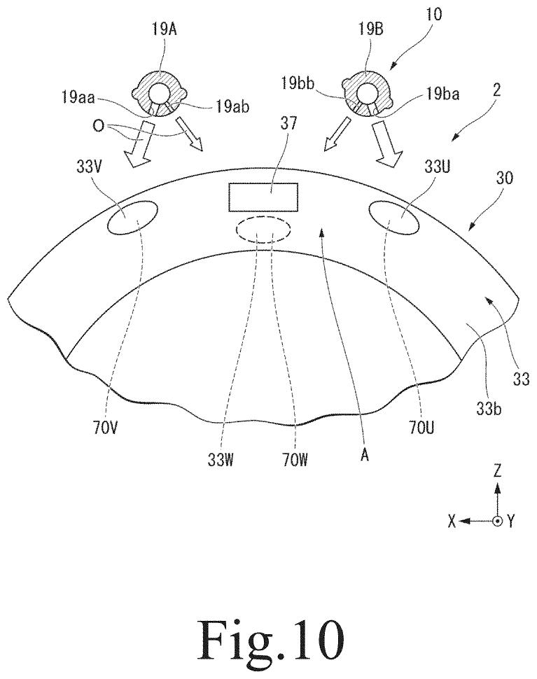

FIG. 10 is a partial front view illustrating a first modification of the rotating electric machine 2 described in the above-described embodiment. In the first modification, the refrigerant supply unit 10 includes a pair of pipes 19A and 19B that supply the oil O to the stator 30. That is, the refrigerant supply unit 10 includes the pipes 19A and 19B as flow passage portions through which the oil O passes. The pair of pipes 19A and 19B extends in the axial direction and is arranged with an interval in the front-rear direction. The pipes 19A and 19B are arranged radially outside the stator 30. The pipes 19A and 19B are located above the stator core 32 and the coil ends 33a and 33b. The pipes 19A and 19B overlap with the stator core 32 and the coil ends 33a and 33b when viewed from the vertical direction.

Between the pair of pipes 19A and 19B, the pipe 19A located on the front side (+X side) is arranged above the coil crossover portion 33V. The pipe 19B located on the rear side (−X side) is arranged above the coil crossover portion 33U.

The pipe 19A has a plurality of refrigerant supply holes 19aa and 19ab which open toward the temperature detection region A of the coil end 33b. The refrigerant supply holes 19aa and 19ab are arranged in a lower portion of the pipe 19A and penetrate a peripheral wall of the pipe 19A in a pipe radial direction. The plurality of refrigerant supply holes 19aa and 19ab include a first refrigerant supply hole 19aa and a second refrigerant supply hole 19ab. The first refrigerant supply hole 19aa opens toward the coil crossover portion 33V and the temperature detection unit 70V. The second refrigerant supply hole 19ab opens toward the coil crossover portion 33W and the temperature detection unit 70W. The opening area of the second refrigerant supply hole 19ab is smaller than the opening area of the first refrigerant supply hole 19aa. Specifically, for example, the opening area of the second refrigerant supply hole 19ab is substantially half the opening area of the first refrigerant supply hole 19aa. Although not particularly illustrated, the number of the first refrigerant supply holes 19aa may be twice the number of the second refrigerant supply holes 19ab, for example, by making the opening area of the first refrigerant supply hole 19aa equal to the opening area of the second refrigerant supply hole 19ab.

The pipe 19B has a plurality of refrigerant supply holes 19ba and 19bb which open toward the temperature detection region A of the coil end 33b. The refrigerant supply holes 19ba and 19bb are arranged in a lower portion of the pipe 19B and penetrate a peripheral wall of the pipe 19B in the pipe radial direction. The plurality of refrigerant supply holes 19ba and 19bb include a first refrigerant supply hole 19ba and a second refrigerant supply hole 19bb. The first refrigerant supply hole 19ba opens toward the coil crossover portion 33U and the temperature detection unit 70U. The second refrigerant supply hole 19bb opens toward the coil crossover portion 33W and the temperature detection unit 70W. The opening area of the second refrigerant supply hole 19bb is smaller than the opening area of the first refrigerant supply hole 19ba. Specifically, for example, the opening area of the second refrigerant supply hole 19bb is substantially half the opening area of the first refrigerant supply hole 19ba. Although not particularly illustrated, the number of the first refrigerant supply holes 19ba may be twice the number of the second refrigerant supply holes 19bb by making the opening area of the first refrigerant supply hole 19ba equal to the opening area of the second refrigerant supply hole 19bb.

Some of the oil O flowing inside the pipe 19A is ejected to the outside of the pipe 19A through the first refrigerant supply hole 19aa, and is supplied from the upper side of the coil end 33b toward the coil crossover portion 33V and the temperature detection unit 70V. The other of the oil O flowing inside the pipe 19A is ejected to the outside of the pipe 19A through the second refrigerant supply hole 19ab, and is supplied from the upper side of the coil end 33b toward the coil crossover portion 33W and the temperature detection unit 70W. Some of the oil O flowing inside the pipe 19B is ejected to the outside of the pipe 19B through the first refrigerant supply hole 19ba, and is supplied from the upper side of the coil end 33b toward the coil crossover portion 33U and the temperature detection unit 70U. The other of the oil O flowing inside the pipe 19B is ejected to the outside of the pipe 19B through the second refrigerant supply hole 19bb, and is supplied from the upper side of the coil end 33b toward the coil crossover portion 33W and the temperature detection unit 70W. According to the first modification, the oil O can be efficiently supplied from the pipes 19A and 19B to the stator 30, and the cooling efficiency of the stator 30 can be improved. In addition, the oil O can be uniformly supplied from the pipes 19A and 19B to the coil crossover portions 33U, 33V, and 33W of the respective phases. Therefore, each of the temperature detection units 70U, 70V, and 70W can measure the temperature of the temperature detection region A, that is, the temperature in the vicinity of the neutral point member 37 with a small variation.

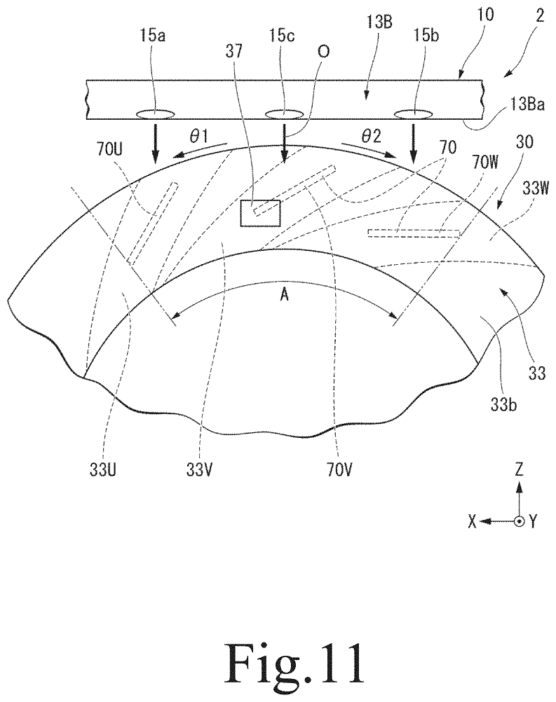

FIG. 11 is a partial front view illustrating a second modification of the rotating electric machine 2 described in the above-described embodiment. In the second modification, the arrangement of the coil crossover portions 33U, 33V, and 33W of the coil end 33b is different from that of the above-described embodiment. As illustrated in FIG. 11, each of the coil crossover portions 33U, 33V, and 33W extends so as to be located on the radially inner side or outer side as proceeding in the circumferential direction. In the illustrated example, each of the coil crossover portions 33U, 33V, and 33W is located on the radially inner side as proceeding to the one circumferential side θ1. The coil crossover portion 33U and the coil crossover portion 33V partially overlap with each other when viewed from the radial direction. The coil crossover portion 33V and the coil crossover portion 33W partially overlap with each other when viewed from the radial direction. Although not particularly illustrated, the coil crossover portion 33W and the coil crossover portion 33U partially overlap with each other when viewed from the radial direction.

Each of the temperature detection units 70U, 70V, and 70W extends in a direction in which each of the coil crossover portions 33U, 33V, and 33W extends. Specifically, the temperature detection units 70U, 70V, and 70W are located on the radially inner side as proceeding to the one circumferential side θ1. In the second modification, radial positions of the temperature detection units 70U, 70V, and 70W are the same. Among the three temperature detection units 70U, 70V, and 70W, the temperature detection unit 10U is located closest to the one circumferential side θ1, the temperature detection unit 70W is located closest to the other circumferential side θ2, and the temperature detection unit 70V is arranged between the temperature detection units 70U and 70W in the circumferential direction. Specifically, the temperature detection unit 70V is arranged in the central portion of the temperature detection region A in the circumferential direction and is located at the uppermost position among the temperature detection units 70U, 70V, and 70W.

In the second modification, the refrigerant supply hole 15a of the refrigerant supply unit 10 opens toward the temperature detection unit 70U. The refrigerant supply hole 15c opens toward the temperature detection unit 70V. The refrigerant supply hole 15b opens toward the temperature detection unit 70W. Further, the temperature detection unit 70V is arranged to overlap with the neutral point member 37 when viewed from the axial direction. According to the second modification, the temperature detection unit 70V can stably measure the temperature in the vicinity of the neutral point member 37.

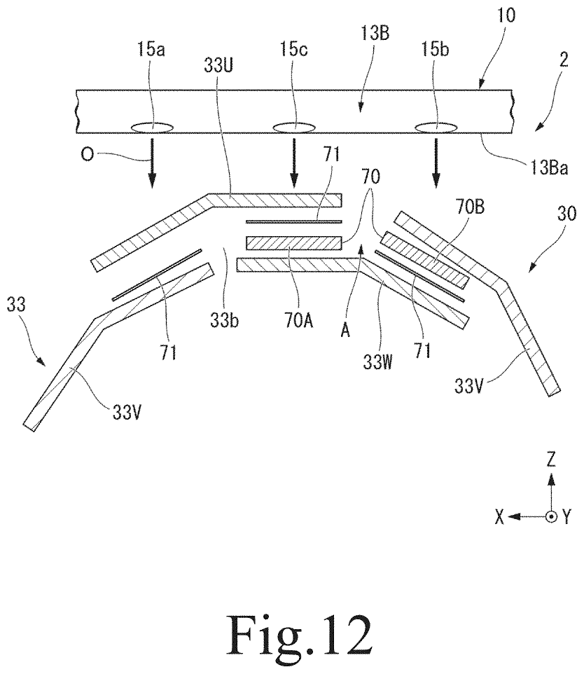

FIG. 12 is a partial front view illustrating a third modification of the rotating electric machine 2 described in the above-described embodiment. Note that FIG. 12 does not illustrate an outer shape of the coil end 33b, the neutral point member 37, and the like. In the third modification, the plurality of temperature detection units 70 are provided in the temperature detection region A, and the plurality of temperature detection units 70 include a first temperature detection unit 70A and a second temperature detection unit 70B. The first temperature detection unit 70A is arranged between a pair of the coil crossover portions 33U and 33W among the three coil crossover portions 33U, 33V, and 33W. The second temperature detection unit 70B is arranged between a pair of the coil crossover portions 33V and 33W formed of a set different from a set of the pair of coil crossover portions 33U and 33W. Each of the temperature detection units 70A and 70B extends in the circumferential direction. Note that the temperature detection unit 70 is not arranged between the pair of coil crossover portions 33U and 33V.

In the third modification, the refrigerant supply hole 15c of the refrigerant supply unit 10 opens toward the first temperature detection unit 70A. The refrigerant supply hole 15b opens toward the second temperature detection unit 70B. The stator 30 includes an insulating sheet 71. A plurality of the insulating sheets 71 are provided on the coil end 33b. The plurality of insulating sheets 71 include an insulating sheet 11 arranged between the first temperature detection unit 70A and the coil crossover portion 33U, and an insulating sheet 71 arranged between the second temperature detection unit 70B and the coil crossover portion 33W. Since the two temperature detection units 10 of at least the first temperature detection unit 70A and the second temperature detection unit 70B are provided according to the third modification, the temperature of the coil end 33b can be accurately measured regardless of the stop position of the rotor 20 in the circumferential direction, for example, when the heat generation of the coil assembly 33 is used when the rotating electric machine 2 is stopped. Therefore, the number of the temperature detection units 70 can be reduced in the third modification as compared with the configuration in which the temperature detection units 70 are each arranged in the coil crossover portions 33U, 33V, and 33W, as in the above-described embodiment. However, the temperature detection unit 70 may be arranged between the pair of coil crossover portions 33U and 33V in addition to the first temperature detection unit 70A and the second temperature detection unit 70B described in the third modification.

Although the examples in which the plurality of temperature detection units 70 are provided in the temperature detection region A has been described in the above-described embodiment and the respective modifications, but the present invention is not limited thereto. One temperature detection unit 70 may be provided in the temperature detection region A. In this case, the temperature detection region A refers to a circumferential region between both ends of one temperature detection unit 70 in the circumferential direction.

The refrigerant circulating inside the housing 6 is not limited to the oil O. For example, an insulating liquid or water may alternatively be used as the refrigerant. In the case where water is used as the refrigerant, an insulating process may be performed on a surface of the stator 30.

The rotating electric machine applied to the present invention is not limited to the motor, and may be a generator. An application of the rotating electric machine is not limited. For example, the rotating electric machine may be mounted on a vehicle for a purpose other than the purpose of rotating the axle 55, or may be mounted on a device other than the vehicle. The posture when the rotating electric machine is used is not particularly limited.

The respective configurations described in the above-described embodiment, modifications, and the like may be combined within the scope not departing from the spirit of the present invention, and addition, omission, replacement, and other changes of the configuration are possible. The present invention is not limited by the above-described embodiment, but is limited only by the scope of the claims.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotating electric machine comprising:
a rotor rotatable about a central axis;
a stator located on radially outside the rotor;
a temperature detection unit that measures a temperature of the stator; and
a refrigerant supply unit that supplies a refrigerant to the stator,
wherein the stator includes:
a stator core; and
a coil assembly held by the stator core,
the coil assembly includes:
a coil end that protrudes from the stator core in an axial direction;
a plurality of coil lead wires; and
at least one neutral point member that electrically connects ends of the plurality of coil lead wires to each other and is arranged at the coil end,
the temperature detection unit is arranged in a temperature detection region that is a partial region in a circumferential direction of the coil end,
the refrigerant supply unit has a refrigerant supply hole that opens toward the temperature detection region of the coil end, and
at least a part of the at least one neutral point member is arranged in the temperature detection region.

2. The rotating electric machine according to claim 1, wherein
the refrigerant supply unit includes a flow passage portion which is arranged radially outside the stator and through which the refrigerant passes, and
the refrigerant supply hole is formed for the flow passage portion.

3. The rotating electric machine according to claim 1, wherein
a plurality of the temperature detection units are provided in the temperature detection region,
a plurality of the refrigerant supply holes are provided in the refrigerant supply unit, and
each of the refrigerant supply holes opens toward each of the temperature detection units.

4. The rotating electric machine according to claim 1, wherein
a plurality of the temperature detection units are provided in the temperature detection region,
the coil end includes at least three coil crossover portions which have different phases and are arranged side by side in a circumferential direction, and
the temperature detection units are each arranged in the three coil crossover portions.

5. The rotating electric machine according to claim 1, wherein
a plurality of the temperature detection units are provided in the temperature detection region,
the plurality of temperature detection units include a first temperature detection unit and a second temperature detection unit,
the coil end includes at least three coil crossover portions having different phases,
the first temperature detection unit is arranged between a pair of coil crossover portions among the three coil crossover portions, and
the second temperature detection unit is arranged between a pair of coil crossover portions formed of a set different from a set of the pair of coil crossover portions.

6. The rotating electric machine according to claim 1, wherein
a plurality of the temperature detection units are provided in the temperature detection region, and
the plurality of temperature detection units are arranged to surround the neutral point member when viewed from the axial direction.

7. The rotating electric machine according to claim 1, wherein
a plurality of the temperature detection units are provided in the temperature detection region, and
distances from the respective temperature detection units to the neutral point member are identical.

8. The rotating electric machine according to claim 1, wherein the temperature detection unit is arranged to overlap with the neutral point member when viewed from the axial direction.

9. The rotating electric machine according to claim 1, wherein the temperature detection unit is embedded in the coil end.

10. A drive apparatus comprising:
the rotating electric machine according to claim 1;
a reduction gear connected to the rotating electric machine;
a differential gear connected to the rotating electric machine via the reduction gear; and
a housing that houses the rotating electric machine, the reduction gear, and the differential gear,
wherein the refrigerant supply unit supplies the refrigerant circulating inside the housing to the stator.
